(19) United States
(12) Patent Application Publication
(10) Pub. No.: US 2010/0052643 A1
(43) Pub. Date: Mar. 4, 2010

(54) BAND-GAP REFERENCE VOLTAGE GENERATOR

(75) Inventors: Young Kyun Cho, Daejeon (KR); Young Deuk Jeon, Daejeon (KR); Jae Won Nam, Daejeon (KR); Jong Kee Kwon, Daejeon (KR)

Correspondence Address: AMPACC Law Group, 3500 188th Street S.W., SUITE 103, Lynnwood, WA, 98037, US

(73) Assignee: Electronics and Telecommunications Research Institute, Daejeon (KR)

(21) Appl. No.: 12/428,425

(22) Filed: Apr. 22, 2009

(30) Foreign Application Priority Data
Sep. 1, 2008 (KR) 10-2008-0085999

(51) Int. Cl. G05F 3/16

(52) U.S. Cl. 323/313

(57) ABSTRACT

A band-gap reference voltage generator is provided. N-channel metal oxide semiconductor (NMOS) transistors are respectively connected to bipolar transistors in parallel. A Complementary To Absolute Temperature (CTAT) voltage that is inversely proportional to absolute temperature is reduced by a threshold voltage of the NMOS transistor. A weight for a temperature coefficient of a Proportional To Absolute Temperature (PTAT) voltage that is directly proportional to absolute temperature is reduced and a resistance ratio for a temperature coefficient of 0 is reduced by about ½, thereby miniaturizing the band-gap reference voltage generator. A reference voltage lower than or equal to 1 V can be provided by resistors respectively connected to the bipolar transistors in parallel.

### CROSS-REFERENCE TO RELATED APPLICATION

This application claims priority to and the benefit of Korean Patent Application No. 10-2008-0085999, filed Sep. 1, 2008, the disclosure of which is incorporated herein by reference in its entirety.

### BACKGROUND

1. Field of the Invention

The present invention relates to a band-gap reference voltage generator, and more particularly, to a band-gap reference voltage generator that can be miniaturized by reducing a size of a resistor occupying a large chip area and can provide a stable reference voltage lower than or equal to 1 V.

2. Discussion of Related Art

In general, all analog/radio frequency (RF) circuits or digital circuits manufactured with chips need a stable and accurate bias voltage for efficient operation. Therefore, a band-gap reference voltage generator is used to provide a stable reference voltage regardless of temperature variation.

However, a conventional band-gap reference voltage generator provides a reference voltage of about 1.25 V, it is not applicable to a circuit designed for applying a voltage lower than or equal to 1 V. There is a problem in that a power supply voltage of at least 1.5 V should be used to ensure smooth operation of transistors used in the reference voltage generator.

On the other hand, a small-area and low-power core chip design for guaranteeing portability and long lifespan is important in widely-used mobile communication terminals.

With the development of deep sub-micron CMOS technology, a small area and low power (or low voltage) may be implemented. However, there is a problem in circuit design since only a core band-gap bias circuit within a chip needs an operation voltage of at least 1.5 V when a low supply voltage is used for a low-power design.

To address this problem, a band-gap reference voltage generator for reducing a reference voltage to 1 V or less using a resistor has been proposed. However, this band-gap reference voltage generator has a problem of increased circuit area since a relatively large-sized resistor is needed.

### SUMMARY OF THE INVENTION

The present application is directed to a compact band-gap reference voltage generator that can be miniaturized and can provide a stable reference voltage lower than or equal to 1 V.

According to an exemplary embodiment of the present invention, there is provided a band-gap reference voltage generator including: first to third p-channel metal oxide semiconductor (PMOS) transistors of a current mirror having gates and sources connected in common to a first node and a power supply voltage, and drains respectively connected to second, third, and fourth nodes; a feedback amplifier having inverted and non-inverted input terminals respectively connected to the second and third nodes and an output terminal connected to the first node; first and second resistors respectively connected between the second node and a fifth node and between the second node and a sixth node; third and fourth resistors respectively connected between the third node and a seventh node and between the fourth node and a ground; first and second bipolar transistors having emitters respectively connected to the fifth node and the third node and collectors and bases connected to the ground; and fourth and fifth n-channel metal oxide semiconductor (NMOS) transistors respectively having gates and drains connected in common to the sixth node and the seventh node and sources connected to the ground, wherein a voltage between the fourth node and the ground is used as a reference voltage.

The reference voltage may be computed by:

$${V}_{ref} = {R}_{4} \cdot {I}_{3} = {R}_{4} \cdot {I}_{2} = {R}_{4} \cdot ( \frac{{V}_{T} \cdot ln n}{{R}_{1}} + \frac{{V}_{BE 2} - {V}_{TH\_M 5}}{{R}_{3}} ) ,$$

where R₁, R₃, and R₄ denote the first, third, and fourth resistors, I₂ and I₃ denote currents flowing through the second and third PMOS transistors, V_{T} denotes a thermal voltage, n denotes the number of bipolar transistors, V_{BE2} denotes a base-emitter voltage of the second bipolar transistor, and V_{TH}_{_{—}}_{M5} denotes a threshold voltage of the fifth NMOS transistor.

That is, a Proportional To Absolute Temperature (PTAT) voltage that is directly proportional to absolute temperature in the band-gap reference voltage generator becomes the thermal voltage V_{T}, a Complementary To Absolute Temperature (CTAT) voltage that is inversely proportional to absolute temperature becomes a difference (V_{BE2}−V_{TH}_{_{—}}_{M5}) between the base-emitter voltage V_{BE2} of the second bipolar transistor and the threshold voltage V_{TH}_{_{—}}_{M5} of the fifth NMOS transistor, and the weight for the thermal voltage V_{T} is computed by α=ln n*(R₃/R₁).

The CTAT voltage that is inversely proportional to absolute temperature is reduced by the threshold voltage V_{TH}_{_{—}}_{M5} of the fifth NMOS transistor. The band-gap reference voltage generator according to an exemplary embodiment of the present invention can reduce the weight α for the thermal voltage V_{T} in order to set a sum of temperature coefficients to 0.

A stable reference voltage lower than or equal to 1 V may be provided by the second and third resistors respectively connected to the first and second bipolar transistors in parallel regardless of temperature variation.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a circuit diagram illustrating a conventional CMOS band-gap reference voltage generator;

FIG. 2 is a circuit diagram illustrating a band-gap reference voltage generator according to an exemplary embodiment of the present invention;

FIG. 3 shows temperature compensation curves of the band-gap reference voltage generator according to an exemplary embodiment of the present invention and the conventional band-gap reference voltage generator; and

FIGS. 4 and 5 are graphs showing temperature coefficient characteristics of the band-gap reference voltage generator according to an exemplary embodiment of the present invention and the conventional band-gap reference voltage generator, and computer simulation results using three simulation models SS, TT, and FF.

### DETAILED DESCRIPTION OF EXEMPLARY EMBODIMENTS

Hereinafter, exemplary embodiments of the present invention will be described with reference to the accompanying drawings. Although exemplary embodiments of the present invention have been disclosed for illustrative purposes, those skilled in the art will appreciate that various modifications, additions, and substitutions are possible, without departing from the scope of the present invention. Therefore, the present invention is not limited to the exemplary embodiments.

To inspect the main differences between the band-gap reference voltage generator according to an exemplary embodiment of the present invention and the conventional band-gap reference voltage generator, structure and operation of the conventional band-gap reference voltage generator will be described in detail.

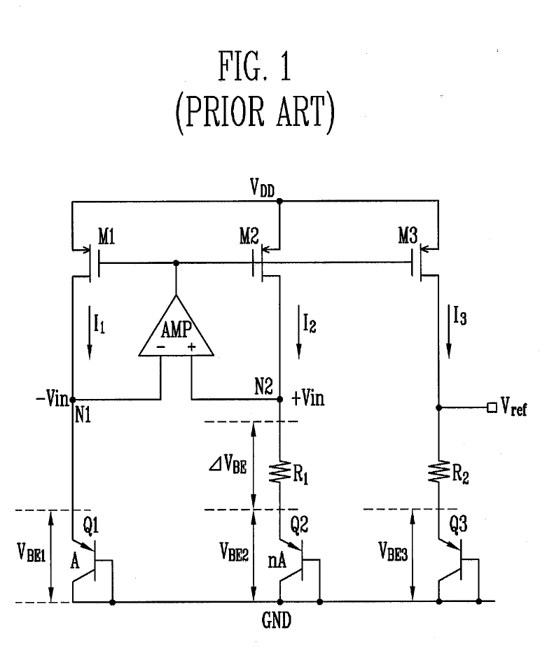

FIG. 1 is a circuit diagram illustrating a conventional complementary metal oxide semiconductor (CMOS) band-gap reference voltage generator.

Referring to FIG. 1, the conventional CMOS band-gap reference voltage generator includes first to third p-channel metal oxide semiconductor (PMOS) transistors M1˜M3, a feedback amplifier AMP, first and second resistors R₁ and R₂, and first to third bipolar transistors Q1˜Q3.

A reference voltage V_{ref} output from the band-gap reference voltage generator configured as described above is independent of temperature and may be numerically described as follows.

A voltage across the first resistor R₁ is computed by ΔV_{BE}=V_{BE1}−V_{BE2}. When ΔV_{BE} is converted into temperature-related expression, Equation 1 is obtained:

$$\begin{matrix}Δ {V}_{BE} = {V}_{BE 1} - Δ {V}_{BE 2} \\ = {V}_{T} \cdot ln \frac{{I}_{C 1}}{{I}_{S 1}} - {V}_{T} \cdot ln \frac{n \cdot {I}_{C 2}}{{I}_{S 2}} \\ = {V}_{T} \cdot ln n\end{matrix} \qquad ( Equation 1 )$$

In Equation 1, I_{S1} and I_{S2} denote reverse saturation currents of the first and second bipolar transistors Q1 and Q2, I_{C1} and I_{C2} denote currents flowing through the first and second bipolar transistors Q1 and Q2, n denotes the number of bipolar transistors, and V_{T} denotes a Proportional To Absolute Temperature (PTAT) voltage as a thermal voltage in the band-gap reference voltage generator.

Since ln n is a constant in Equation 1, the voltage ΔV_{BE} across the first resistor R₁ increases in direct proportion to V_{T}, which is directly proportional to temperature.

Next, a current I₂ flowing through the first resistor R₁ is mirrored to the third PMOS transistor M3 by directly reproducing temperature characteristics of ΔV_{BE}. A mirrored current I₃ flows through the second resistor R₂ and the third bipolar transistor Q3.

A base-emitter voltage V_{BE3} of the third bipolar transistor Q3 decreases in inverse proportion to the temperature.

ΔV_{BE} is a temperature variable increasing in direct proportion to the temperature and V_{BE3} is a temperature variable decreasing in inverse proportion to the temperature. When the two temperature variables are set to zero by properly adjusting a resistance ratio of the first and second resistors R₁ and R₂, a reference voltage V_{ref} that is independent of temperature can be obtained, as shown in Equation 2:

$$\begin{matrix}{V}_{ref} = {V}_{BE 3} + \frac{{R}_{2}}{{R}_{1}} Δ {V}_{BE} \\ = {V}_{BE 3} + \frac{{R}_{2}}{{R}_{1}} ( {V}_{T} ln n ) \\ \approx 1.25 V\end{matrix} \qquad ( Equation 2 )$$

As shown in Equation 2, the conventional band-gap reference voltage generator has a perfect temperature characteristic (that is, a temperature coefficient of 0) around a theoretical reference voltage V_{ref} of about 1.25 V, it is not applicable to a circuit designed for applying a voltage lower than or equal to 1 V. There is a problem in that a power supply voltage of at least 1.5 V should be used to ensure smooth operation of transistors used in the reference voltage generator.

In contrast, the band-gap reference voltage generator according to an exemplary embodiment of the present invention can provide a stable reference voltage lower than or equal to 1 V and can be miniaturized. Structure and operation of the band-gap reference voltage generator according to an exemplary embodiment of the present invention will be described in detail.

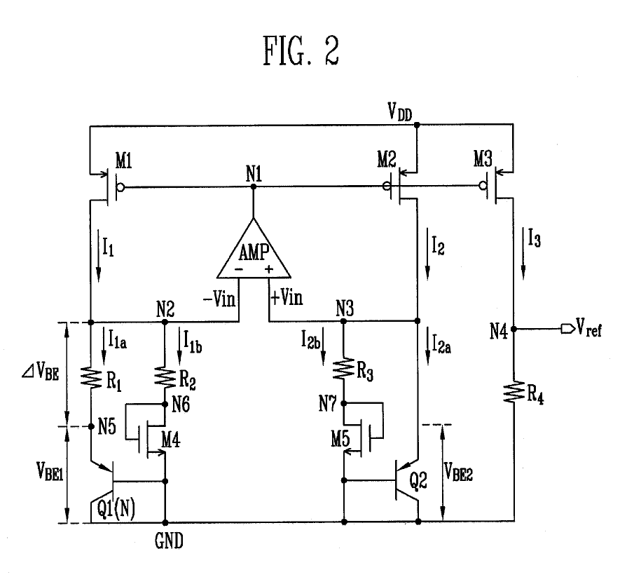

FIG. 2 is a circuit diagram illustrating a band-gap reference voltage generator according to an exemplary embodiment of the present invention.

Referring to FIG. 2, the band-gap reference voltage generator includes first to third PMOS transistors M1˜M3, a feedback amplifier AMP, first to fourth resistors R₁˜R₄, first and second bipolar transistors Q1˜Q2, and fourth and fifth NMOS transistors M4 and M5.

A connection relation between the components will be described briefly.

The first to third PMOS transistors M1˜M3 are configured in the form of a current mirror. The first to third PMOS transistors M1˜M3 have gates connected in common to a first node N1, sources connected in common to a power supply voltage V_{DD}, and drains respectively connected to second, third, and fourth nodes N2, N3, and N4. To improve Power Supply Rejection Ratio (PSRR) characteristics, it is possible to configure the current mirror by stacking multi-stage PMOS transistors.

The feedback amplifier AMP has inverted and non-inverted input terminals −Vᵢₙ and +Vᵢₙ respectively connected to the second and third nodes N2 and N3, and an output terminal connected to the first node N1.

The first resistor R₁ is connected between the second node N2 and a fifth node N5, the second resistor R₂ is connected between the second node N2 and a sixth node N6, and the third resistor R₃ is connected between the third node N3 and a seventh node N7. The fourth resistor R is connected between the fourth node N4 and a ground GND and a reference voltage V_{ref} is connected to the fourth node N4.

The first bipolar transistor Q1 has an emitter connected to the fifth node N5 and a collector and base connected to the ground GND. The second bipolar transistor Q2 has an emitter connected to the third node N3 and a collector and base connected to the ground GND.

The fourth NMOS transistor M4 has a gate and drain connected in common to the sixth node N6 and a source connected to the ground GND. The fifth NMOS transistor M5 has a gate and drain connected in common to the seventh node N7 and a source connected to the ground GND.

When an output voltage of the feedback amplifier AMP is applied to gates of the first to third PMOS transistors M1˜M3 in a state in which the first to third PMOS transistors M1˜M3 are in a saturation mode, the same current flows through the first to third PMOS transistors M1˜M3 by current mirroring. That is, I₁=I₂=I₃. Here, the current I₁ is divided into I₁ₐ and I_{1b}, and the current I₂ is divided into I₂ₐ and I_{2b}. That is, I₁=I₁ₐ+I_{1b}, and I₂=I₂ₐ+I_{2b}.

The voltages of the second node N2 and the third node N3 have the same magnitude by current mirroring of I₁ and I₂. When the second resistor R₂ is the same as the third resistor R₃, that is, when R₂=R₃, I₁ₐ=I₂ₐ and I_{1b}=I_{2b}.

The current I₂ₐ flowing through the second bipolar transistor Q2 can be defined as shown in Equation 3:

I₂ₐ=I_{S2}·e^{V}^{_{BE2}}^{/V}^{_{T}} (Equation 3)

In Equation 3, I_{S2} and V_{BE2} each denote a reverse saturation current and a base-emitter voltage of the second bipolar transistor Q2, and V_{T} denotes a thermal voltage.

When Equation 3 is converted into a numerical expression related to the base-emitter voltage V_{BE2} of the second bipolar transistor Q2, Equation 4 is obtained:

$${V}_{BE 2} = {V}_{T} \cdot ln \frac{{I}_{2 a}}{{I}_{S 2}} \qquad ( Equation 4 )$$

The base-emitter voltage V_{BE2} of the second bipolar transistor Q2 computed by Equation 4 decreases in inverse proportion to the temperature.

The voltage ΔV_{BE} across the first resistor R₁ can be expressed by Equation 5:

$$\begin{matrix}Δ {V}_{BE} = {V}_{BE 2} - {V}_{BE 1} \\ = {V}_{T} \cdot ln \frac{{I}_{2 a}}{{I}_{S 2}} - {V}_{T} \cdot ln \frac{{I}_{1 a}}{{I}_{S 1}} \\ = {V}_{T} \cdot ln n\end{matrix} \qquad ( Equation 5 )$$

In Equation 5, n denotes the number of bipolar transistors and V_{BE1} denotes a base-emitter voltage of n bipolar transistors connected in parallel.

The voltage ΔV_{BE} across the first resistor R₁ computed by Equation 5 increases in direct proportion to the temperature.

Accordingly, the currents I₂ₐ and I_{2b} can be expressed as shown in Equation 6:

$$\begin{matrix}{I}_{2 a} = {I}_{1 a} = \frac{Δ {V}_{BE}}{{R}_{1}} = \frac{{V}_{T} \cdot ln n}{{R}_{1}} & ( Equation 6 ) \\ {I}_{2 b} = \frac{{V}_{BE 2} - {V}_{TH\_M 5}}{{R}_{3}} & \end{matrix}$$

Since I₂ₐ+I_{2b}=I₂=I₃ in Equation 6, a target reference voltage V_{ref} can be expressed as shown in Equation 7:

$$\begin{matrix}{V}_{ref} = {R}_{4} \cdot {I}_{3} \\ = {R}_{4} \cdot {I}_{2} \\ = {R}_{4} \cdot ( \frac{{V}_{T} \cdot ln n}{{R}_{1}} + \frac{{V}_{BE 2} - {V}_{TH\_M 5}}{{R}_{3}} )\end{matrix} \qquad ( Equation 7 )$$

Referring to Equation 7, a PTAT voltage that is directly proportional to absolute temperature in the band-gap reference voltage generator becomes V_{T}, and a CTAT voltage that is inversely proportional to absolute temperature becomes a difference (V_{BE2}−V_{TH}_{_{—}}_{M5}) between the base-emitter voltage V_{BE2} of the second bipolar transistor Q2 and the threshold voltage V_{TH}_{_{—}}_{M5} of the fifth NMOS transistor M5.

When weights for temperature coefficients of the PTAT voltage V_{T} and the CTAT voltage (V_{BE2}−V_{TH}_{_{—}}_{M5}) are denoted by α and β, the reference voltage V_{ref} can be obtained regardless of temperature variation when the temperature coefficients are set to zero such that α*{∂V_{T}/∂T}+β{∂(V_{BE2}−V_{TH}_{_{—}}_{M5})/∂T}=0, by properly selecting α and β.

Since the CTAT voltage by the fourth and fifth NMOS transistors M4 and M5 is reduced by the threshold voltage V_{TH}_{_{—}}_{M5} of the fifth NMOS transistor M5, the weight α(=ln n*(R₃/R₁)) for the temperature coefficient of the PTAT voltage is reduced in the band-gap reference voltage generator according to an exemplary embodiment of the present invention compared to the conventional band-gap reference voltage generator.

Table 1 shows a comparison of the conventional band-gap reference voltage generator and the band-gap reference voltage generator according to an exemplary embodiment of the present invention.

TABLE 1

| | Temperature | | |
|---|---|---|---|
| | coefficient of | Temperature coefficient | |
| | PTAT voltage | of CTAT voltage | Weight α |
| Conventional | ∂V_{T}/∂T = | ∂V_{BE}/∂T = | ln n * R₃/R₁ = |
| | 0.083 mV/° C. | −1.65 mV/° C. | 21.82 |
| Present | ∂V_{T}/∂T = | ∂(V_{BE2} − V_{TH}_{_{—}}_{M5})/∂T = | ln n * R₃/R₁ = |
| Invention | 0.083 mV/° C. | −0.45 mV/° C. | 11.09 |

Referring to Table 1, the temperature coefficient (∂V_{BE}/∂T) of the CTAT voltage in the conventional band-gap reference voltage generator is four times greater than in the band-gap reference voltage generator according to an exemplary embodiment of the present invention. Accordingly, it can be seen that the weight α for the temperature coefficient of the PTAT voltage for setting a sum of temperature coefficients to 0 is also doubled.

That is, the resistance ratio R₃/R₁ of the third resistor R₃ and the first resistor R₁ should increase at least 20 times in order to set all temperature coefficients to 0 in the conventional band-gap reference voltage generator. Since a sum of temperature coefficients can be set to 0 even when the resistance ratio R₃/R₁ increases only about 10 times, the size of a resistor occupying a large chip area can be reduced by about ½, thereby miniaturizing the band-gap reference voltage generator.

Since the temperature coefficient of the CTAT voltage is reduced by the fourth and fifth NMOS transistors M4 and M5 and the second and third resistors R₂ and R₃ respectively connected to the first and second bipolar transistors Q1 and Q2 in parallel in the band-gap reference voltage generator according to an exemplary embodiment of the present invention, a stable reference voltage V_{ref} that is lower than or equal to 1 V can be provided regardless of temperature variation.

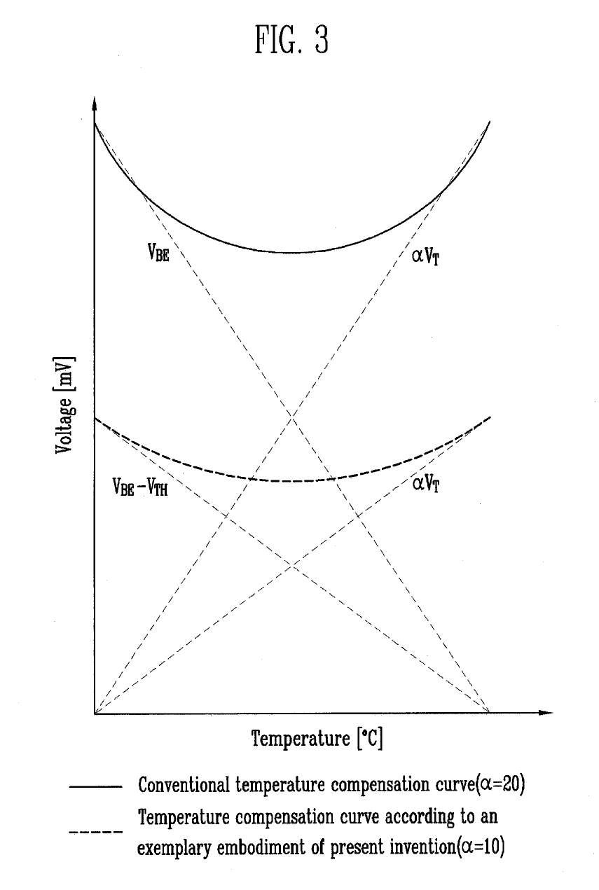

FIG. 3 shows temperature compensation curves of the band-gap reference voltage generator according to an exemplary embodiment of the present invention and the conventional band-gap reference voltage generator.

As seen in FIG. 3, a temperature coefficient of a CTAT voltage is reduced and a curvature of a temperature compensation curve is reduced in the band-gap reference voltage generator according to an exemplary embodiment of the present invention compared to the conventional band-gap reference voltage generator.

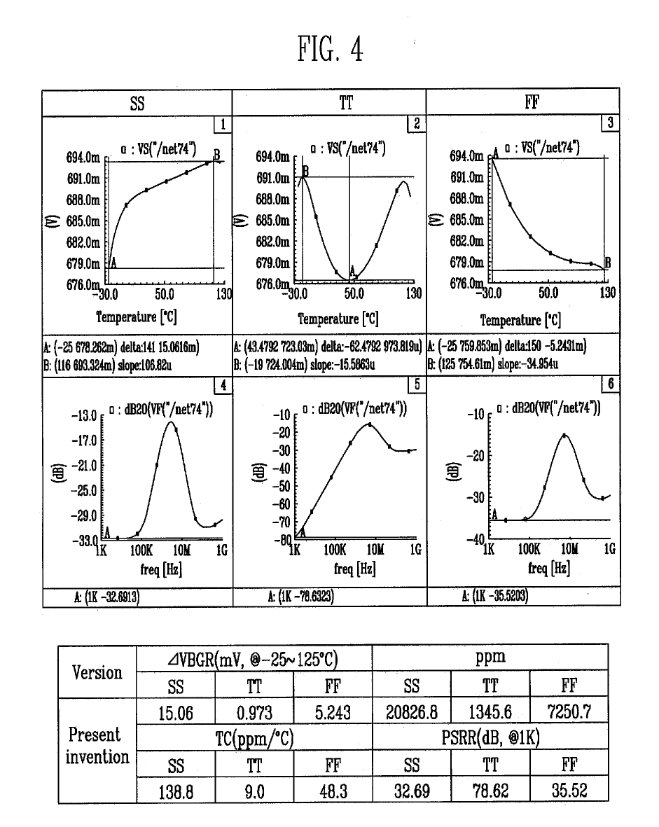

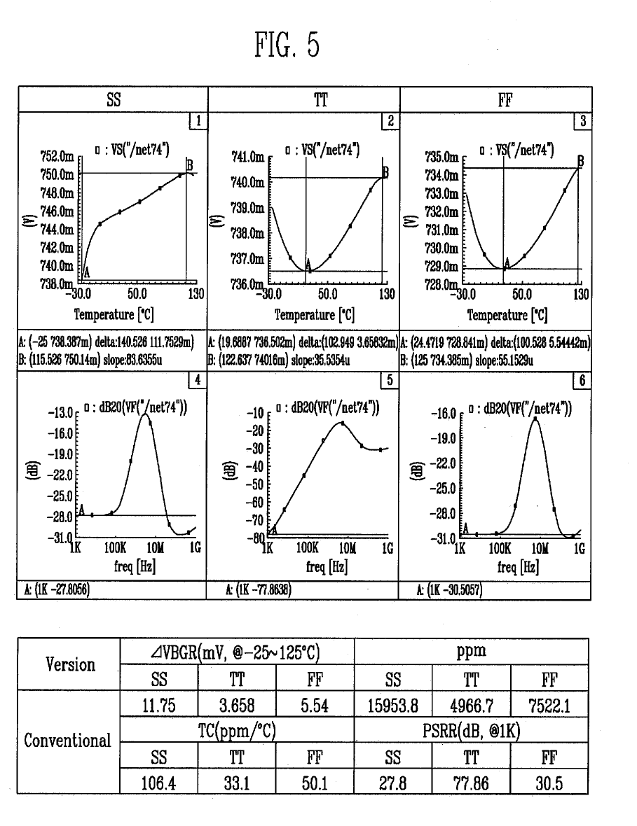

FIGS. 4 and 5 are graphs showing temperature coefficient characteristics of the band-gap reference voltage generator according to an exemplary embodiment of the present invention and the conventional band-gap reference voltage generator, and computer simulation results using three simulation models SS, TT, and FF.

Referring to the computer simulation results of TT shown in FIGS. 4 and 5, the conventional band-gap reference voltage generator has a high temperature coefficient of 33.1 ppm/° C. However, the band-gap reference voltage generator according to an exemplary embodiment of the present invention has a very low temperature coefficient of 9 ppm/° C. and a PSRR of 78 dB.

According to the present invention, a band-gap reference voltage generator can be miniaturized by reducing the size of a resistor occupying a large chip area, since a resistance ratio for a temperature coefficient of 0 is reduced by about ½.

According to the present invention, a stable reference voltage lower than or equal to 1 V can be provided regardless of temperature variation.

While the present invention has been shown and described in connection with exemplary embodiments thereof, it will be apparent to those skilled in the art that various modifications can be made without departing from the spirit and scope of the invention as defined by the appended claims.

What is claimed is:

1. A band-gap reference voltage generator comprising:
first to third p-channel metal oxide semiconductor (PMOS) transistors of a current mirror having gates and sources connected in common to a first node and a power supply voltage, and drains respectively connected to second, third, and fourth nodes;
a feedback amplifier having inverted and non-inverted input terminals respectively connected to the second and third nodes and an output terminal connected to the first node;
first and second resistors respectively connected between the second node and a fifth node and between the second node and a sixth node;
third and fourth resistors respectively connected between the third node and a seventh node and between the fourth node and a ground;
first and second bipolar transistors having emitters respectively connected to the fifth node and the third node and collectors and bases connected to the ground; and
fourth and fifth n-channel metal oxide semiconductor (NMOS) transistors respectively having gates and drains connected in common to the sixth node and the seventh node and sources connected to the ground,
wherein a voltage between the fourth node and the ground is used as a reference voltage.

2. The band-gap reference voltage generator of claim 1, wherein the second and third resistors have the same resistance.

3. The band-gap reference voltage generator of claim 2, wherein currents flowing through the first resistor and the second bipolar transistor have the same magnitude and currents flowing through the second resistor and the third resistor have the same magnitude.

4. The band-gap reference voltage generator of claim 3, wherein a voltage across the first resistor increases in direct proportion to temperature and a base-emitter voltage of the second bipolar transistor decreases in inverse proportion to temperature.

5. The band-gap reference voltage generator of claim 1, wherein the reference voltage is computed by:
$${V}_{ref} = {R}_{4} \cdot {I}_{3} = {R}_{4} \cdot {I}_{2} = {R}_{4} \cdot ( \frac{{V}_{T} \cdot ln n}{{R}_{1}} + \frac{{V}_{BE 2} - {V}_{TH\_M 5}}{{R}_{3}} ) ,$$
where R₁, R₃, and R₄ denote the first, third, and fourth resistors, I₂ and I₃ denote currents flowing through the second and third PMOS transistors, V_{T} denotes a thermal voltage, n denotes the number of bipolar transistors, V_{BE2} denotes a base-emitter voltage of the second bipolar transistor, and V_{TH}_{_{—}}_{M5} denotes a threshold voltage of the fifth NMOS transistor.

6. The band-gap reference voltage generator of claim 5, wherein a weight for the thermal voltage (V_{T}) is computed by α=ln n*(R₃/R₁) and is reduced such that the reference voltage becomes independent of temperature.

7. The band-gap reference voltage generator of claim 5, wherein the reference voltage is between 0 and 1 V.

8. The band-gap reference voltage generator of claim 5, wherein a resistance of the fourth resistor is adjusted such that the reference voltage is independent of temperature.
